(19) United States
(12) Patent Application Publication
(10) Pub. No.: US 2005/0234976 A1
(43) Pub. Date: Oct. 20, 2005

(54) System and method for deriving an object oriented design from the business rules of a legacy application

(75) Inventors: Ioan Mihai Oara, Cary, NC (US); Alex Rukhlin, Cary, NC (US); Florin Florea, Cary, NC (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(73) Assignee: Relativity Technologies, Inc., Raleigh, NC (US)

(21) Appl. No.: 11/011,283

(22) Filed: Dec. 14, 2004

Related U.S. Application Data
(63) Continuation-in-part of application No. 10/827,953, filed on Apr. 20, 2004.

(51) Int. Cl. G06F 17/30

(52) U.S. Cl. 707/103 R

(57) ABSTRACT

A method and system serves to derive class definitions from the program code of a legacy system. The objects of the legacy application are identified, and separately all the business rules of the application are identified. Each object has a data structure which describes its properties. The fields in this data structure are used to derive the candidate data attributes of the object. All the business rules which use some of the data attributes of the object either as input or output are grouped together as candidate methods of the object. The user selects some of the candidate data attributes and some of the candidate methods and uses them to designate a new class. The user may also decide if the data elements used in the methods are method parameters or global data attributes of the class.

### CROSS REFERENCE TO RELATED APPLICATIONS

This application is a continuation-in-part of co-pending application Ser. No. 10/827,953, filed Apr. 20, 2004 and entitled “System and Method for Business Rule Identification and Classification”. This application claims priority to the filing date of said application Ser. No. 10/827,953, the disclosure of which is specifically incorporated by reference herein.

### FIELD OF THE INVENTION

This invention relates to a method and system for grouping variables in legacy program code such as COBOL, PLI, NATURAL and other languages, to describe the program. More specifically, the invention relates to a method of identifying variables including objects, data elements and business rules present throughout the program, associating them together and creating a class for each object so associated. The classes are then arranged in a class diagram which is an object oriented description of the description of the program.

### BACKGROUND OF THE INVENTION

Legacy applications may contain large volumes of code. As time passes, knowledge about the code may be lost for various reasons, including the fact that the original developers of the code are no longer working for the company for which the program was developed. To the extent that legacy code continues to be used in company operations, it is important that the existing legacy code be analyzed and understood, particularly for updates and adaptations necessary to the evolution of the company.

More specifically, legacy code may contain technical artifacts which are helpful in the implementation and usually contains some logic directly related to the business of the company in which the code is used. The identification of this logic is especially important. For purposes of the discussion herein, it is noted that such fragments of code which implement particular business requirements are usually called “business rules”.

This is important for a number of reasons, including the fact that the business of the company may change, and such business rules may be required to be modified to reflect more modern business operations. Due to the fact that the legacy code was written, in often cases, many years prior to the need to change the business rule or understand the business rule, identification of the portions of the code in which the rule resides may be difficult if not impossible.

This is further complicated by the fact that in many cases, the program embodying the legacy code was written in an unstructured manner so that the business rules are populated throughout the program in an unstructured and often unpredictable manner.

In accordance with the invention, a method is provided which allows easy identification and classification of the business rules in such programs, including classifying the business rule and storing information about where the business rule is located for further use, particularly for legacy programs.

More recently, as described in patent application Ser. No. 10/827,953 there has been developed a method of identifying business rules in legacy programs. More specifically, the method provides for identifying business rules relating to both inputs and outputs in program code of, for example, legacy programs.

With respect to identification of business rules relating to inputs in a program, the method involves identifying all input ports in a program code. The data structure associated with each input port is then determined, and for each field in each input port, the outgoing data flow is determined. For each such field in the data flow, a determination is made about whether there is a test used to branch in the program. If a test exists, a validation rule (which is a business rule identified as associated with an input port) is created and the rule is stored.

The parent application also describes a method of identifying business rules relating to outputs in program code of a legacy program. The method involves identifying all output ports in the program. For each output port, the data structure associated with each output port is determined and for each field in each output port, the computation path is also determined. A further determination identifies whether the path is not empty, and if the computation path is not empty, a computation rule (which is a business rule identified as associated with an output port and its computation path) is created and the rule is stored.

The described method also involves identifying business rules relating to both inputs and outputs in program code of a program, and involves the aforementioned combination of steps.

The parent application also describes a system for identifying business rules relating to inputs and outputs in a program. The system includes an interface, for example, a display for displaying all input ports and all output ports in the program code. The display can be associated with a computer, having the program code loaded thereon and programmed for finding and displaying the input ports and output ports. The interface further includes means for determining the data structure associated with each input port and with each output port. There are also means for determining the outgoing data flow for each field in each input port, and means for determining the computation path for each field in each output port. In addition, the system includes means for determining whether a test is used to branch in the input port outgoing data flow, and means for creating a validation rule and storing the validation rule if a test exists. Finally, the system also includes means for determining if the computation path is not empty for each computation path of each output data port, and means for creating a computation rule and for storing the computation rule if the computation path is not empty.

The system may be implemented on a computer with a display and input device, which has been programmed to achieve the function of the various means described therein.

### BRIEF SUMMARY OF THE INVENTION

The invention, in one aspect, presupposes that business rules in legacy programs which are to be characterized, have gone through a process where the business rules therein have been identified and analyzed, for example, through a system and method such as that described in parent application Ser. No. 10/827,953.

Thus, in one aspect, the invention is a method of grouping variables in the legacy program code of a program to describe the program. In accordance with the invention “objects” in the program code are identified. An “object” is a well known term in modern programming and in the context of the invention refers to things that can be acted on, such as a customer, account or branch.

Thus, all the objects in the legacy program are identified. For each object, all data elements in the system which refer to the object are identified. The way data elements are named gives appropriate indications to which object they refer.

For instance, in the case of a “customer” as an object, representative data elements may include “customer name” or other “customer” attributes. Thus, there would exist a record of a data structure called “customer” which includes subfields thereunder.

The business rules which deal with the identified data elements are also identified as part of the process. Business rules under this invention can generally be thought of as “methods” of acting on objects. Thus, in accordance with the invention, data elements and business rules to be associated with each object are selected, and a class is created for each identified object. The class is made up of the object and the data elements and business rules selected for association with the respective object.

In another aspect, the invention relates to a system for accomplishing the aforementioned. The system can be implemented through, for example, a computer operated on by a user, and programmed to create the noted classes and implement the aforementioned functions.

### BRIEF DESCRIPTION OF THE SEVERAL VIEWS OF THE DRAWING

Having thus briefly described the invention, the same will become better understood from the following detailed discussion, made with reference to the accompanying drawing, wherein:

FIG. 1 is a block diagram illustrating how a parsing of a legacy program can be used to identify business rules in program code;

FIG. 2 is a screenshot of how a user can locate rules manually or automatically;

FIG. 3 is a screenshot illustrating an implementation of the detection of output or computation rules in program code;

FIG. 4 is a block diagram illustrating how input rules in program code are identified, and a rule created and stored for later use;

FIG. 5 is a block diagram illustrating how output rules in program code are identified, created and stored for later use;

FIG. 6 is a screen shot illustrating a typical class diagram created with the tool in accordance with the invention;

FIG. 7 is a popup menu which allows the user to delete automatically generated variables from rules selected in preparing a class diagram;

FIG. 8 is a screen shot illustrating the variables for each rule selected for creating the class diagram;

FIG. 9 is a screen shot illustrating each business rule as a separate column and variables taken into consideration only once in the list;

FIG. 10 is a screen shot illustrating how class identifiers are edited;

FIG. 11 is a screenshot of how to add and edit for an object;

FIG. 12 is a screenshot illustrating how an object is “extended”;

FIG. 13 is a screenshot illustrating how an interface is implemented;

FIG. 14 is a screenshot illustrating how method identifiers can be edited;

FIG. 15 is a screenshot illustrating how the returned type of methods and type of parameters or attributes are edited by selecting the appropriate links;

FIG. 16 is a screenshot illustrating how method parameters can be moved up as global attributes of a class and vice versa;

FIG. 17 is a screenshot illustrating how a parameter can be edited, deleted or made an attribute;

FIG. 18 is a window illustrating how through a view menu, it is possible to show or hide any of the panels in the tool, and set the user preferences;

FIG. 19 is a window illustrating how it is possible to make several libraries available to the tool;

FIGS. 20-22 are various windows and displays illustrating how the filtering of the rules and properties are operated;

FIG. 23 is a window illustrating how rules are found for a selected variable; and

FIG. 24 is a window illustrating how rules are found for classes.

### DETAILED DISCUSSION OF THE INVENTION

As discussed in co-pending parent application Ser. No. 10/827,953, in accordance with the method described therein, there is described a practical method of identifying business rules in program code, particularly legacy code, including COBOL, PLI, NATURAL and other languages. Such a method is useful in the implementation of the current invention, and is discussed in greater detail hereinafter as a background to the follow-on description of the invention.

As discussed, many programs, and in particular legacy applications may contain large volumes of code. Knowledge about the code may have been lost for a number of reasons, including the fact that developers of the original code are no longer working for the company. It is therefore important for continuing operations of a company that the legacy code be analyzed and understood.

It is important to appreciate that programs, and especially legacy code, may contain technical artifacts which are helpful in the implementation and usually contain some logic directly related to the business of the company. An identification of the logic is particularly important, and the fragments of code which implement particular business requirements, as noted in parent application Ser. No. 10/827,953 are usually called business rules. As described herein, such “business rules” of the program, particularly legacy applications are identified, and the meaning of the business rule is determined.

The business rule can be identified, for example, using a computer with a display, memory, storage and input devices, etc., programmed to operate as described herein as a system having various program modules or portions as means to achieve the described functions.

Business rules generally fall into two categories. Generally, these categories are 1) rules related to program inputs, and 2) rules related to program outputs. The rules related to input data are usually “validations” and they describe some restrictions on the data. The rules related to output data are usually “computation” rules that show how to compute a value or how to make a decision. Decisions and computations are essentially of the same nature, a decision being a computation of a binary value field, i.e., Yes or No.

As further example with respect to input rules in a program, it is noted that for input ports, programs have statements on how data is received. Such statements can be viewed by examination of the program code on screen or in a file or through specific means such as the use of another program such as a standard and conventional parsing program. Each statement has a syntax which can be recognized by certain keywords, for example, a “read”, or a “call” or a “receive.” There are also data structures which store or hold data which is read into the program. The way in which most programs work is that a data structure is declared (specifying its name, size, subfields, etc.) data is then read and put into the data structure. The fields in the data structure are then tested to determine its validity. For example, a program may receive information from a screen, including phone numbers, which must have at least seven numbers. The program checks the number of digits in the phone number. If the phone number is less than seven digits, a message is issued by the program and posted on the screen. The fact that an input field is verified and a message is issued identifies this portion of code as a business rule. The business rule is named in accordance with the function it provides and pointers are set and stored to identify the start and the end of the business rule in the code.

With respect to output rules, they are generally identified through the detection of output ports. The output ports issue a “write” or “send” statement. The output rules refer to data associated with the output ports. This is contrasted with input rules which are associated with input ports.

For the output ports, the data structure is identified as before. The location of the data fields is identified and the computation path which ends in the output port is determined. The computation path consists of all statements of the program which have an influence on the field at a particular point in the program. If no computation path is found, then there is no business rule. On the other hand, if a computation path is found, then the business rule is identified and pointers are set to the start and the end of each fragment of the code in the computation path. The rule is named and stored.

As a further example of a computation rule, in the case of an insurance program an operator may enter data relating to the date of birth of a potential insured party. After the date of birth of the party is entered, the program code computes the age of the party, and for example, if below a certain age, would relay the statement to the output port that the party is not approved because the party is underage.

Thus, as may be appreciated, and already discussed, all business rules fall into two categories, rules related to program inputs, and rules related to program outputs.

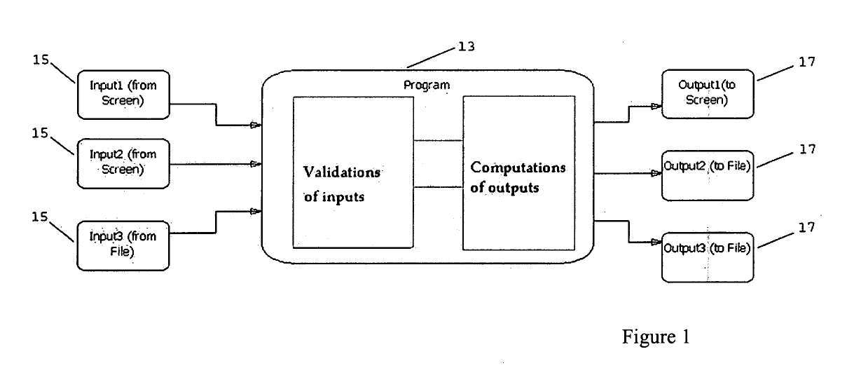

As further illustrated in FIG. 1, in analyzing the program, it is important to appreciate that a program 13 receives data from outside, such as input from screens 15. The program 13 uses the “input” business rules to validate that the data received is correct and that the program can proceed to compute the outputs. If the data is not correct, a message is issued. The “output” business rules compute the outputs of the program and the output data is sent to a screen, file or another device 17.

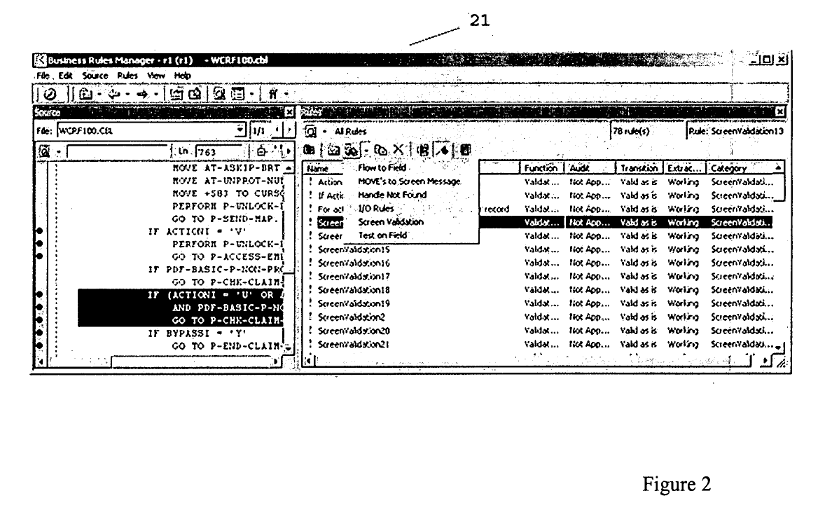

As shown in FIG. 2, in implementing the rule identification process, a user may locate rules manually or automatically by selecting from one of the methods displayed in the menu.

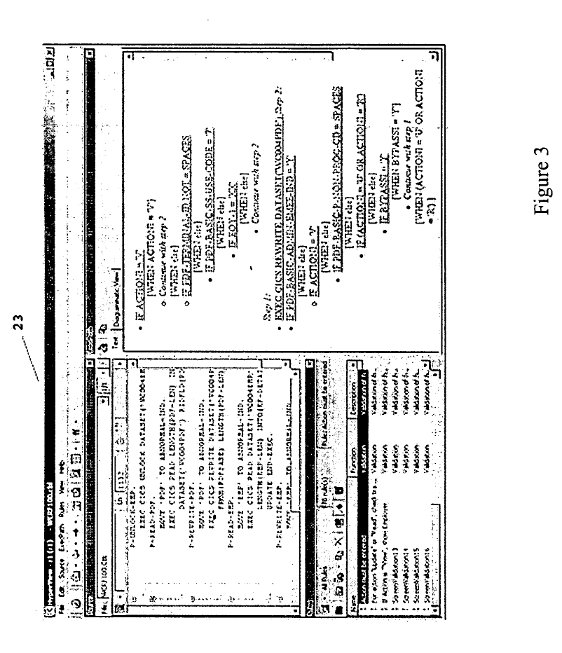

In FIG. 3, implementation of “output” rule detection involves a user statement in the program 23 (seen on the left), and the system detects all the conditions leading to the execution of the statement.

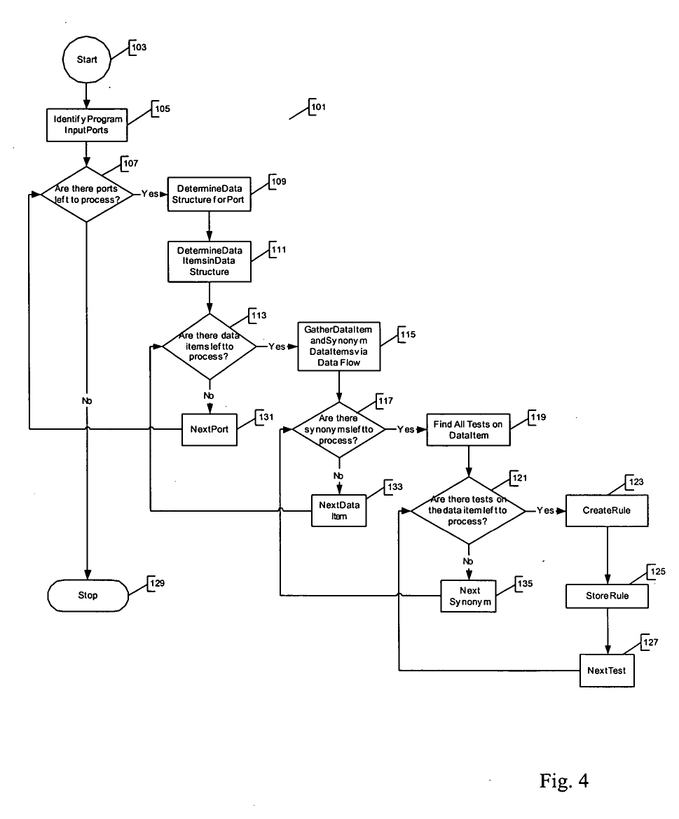

The method of detecting input rules is illustrated in greater detail in FIG. 4, which is a block diagram 101 of the steps taken in determining the input business or validation rules. The method starts at step 103, where it is assumed that the program was parsed using common parsing techniques which extract internal program information and is available for some automatic analysis. At step 105, all of the input ports in the program are identified, either by manual inspection or by use of conventional parsing programs. Then each input port is inspected. More specifically at step 107 a check is made if any not inspected ports are left and a next input port is investigated. If no more input ports are left the method stops at step 129. For the input port selected at step 107, the data structure for that input port is determined at step 109. At step 111 all data items of the data structure are detected. Then each data item is processed. At step 113 a check is made to determine if any not processed data items are left in the data structure, and a next data item is taken into account. If no data items are left, the method continues with the next port at step 131. At step 115 for the data item selected at step 113, a set is created, which consists of the data item itself and all data items receiving values from the original one via dataflow in the program. Then all the elements of this set are investigated. At step 117 a check is made to determine if elements not yet processed are left in the set, and a next element is then processed. If no such element is found the method continues with the next data item at step 133. Step 119 finds all tests to be conducted on the element. Step 121 checks if there are any tests on the element left to process, i.e. data item or its synonym, and for each of them creates a rule at step 123, stores it at step 125 and continues with the next test at step 127. If there were no tests or all of them are already stored as rules, the method continues with the next element at step 135.

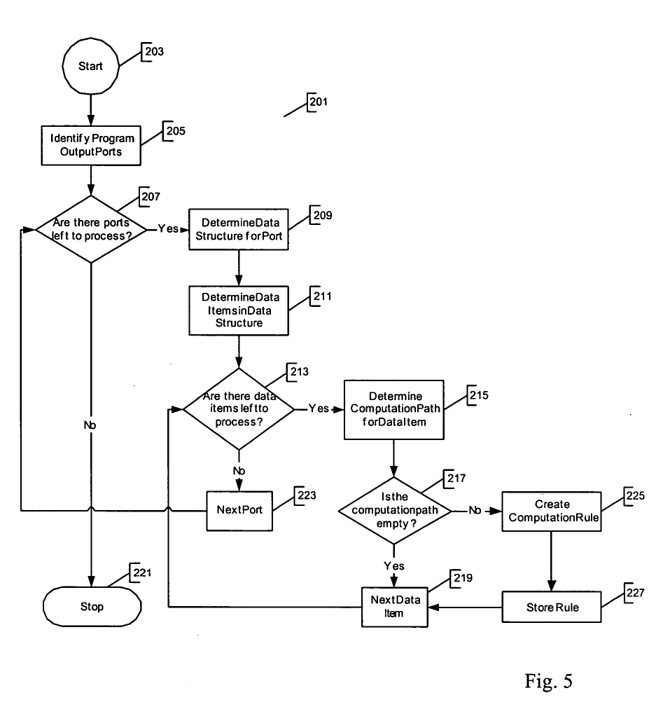

In FIG. 5, block diagram 201 illustrates how output rules in program code are detected, created and stored. The method starts at step 203, where it is assumed that the program was parsed and is available for some automatic analysis. At step 205, all output ports are identified, either by manual inspection or by use of conventional parsing programs. Then each input port is inspected. More specifically, at step 207 a check is made to determine if any ports not yet inspected are left and a next output port is investigated. If no more output ports are left, the method stops at step 221. For the output port selected at step 207, the data structure for that output port is determined at step 209. At step 211 all data items of the data structure are detected. Then each data item is processed in the following steps. At step 213 a check is made to determine if any not processed data items are left in the data structure and a next data item is taken into account. If no data items are left, the method continues with the next port at step 223. At step 215 for the data item selected at step 213, its computational path for it is determined. At step 217 a check is made to determine whether the path is empty. If is the path is empty, the method continues with the next data item at step 219. If the path is not empty, then at step 225 the process creates a rule, which is stored at step 227. The method continues then with the next data item at step 219.

For both input and output rules, the method in accordance with the invention captures the business rule, including the name, the field to which it applies, the specific port to which it is associated, i.e., “read”, or “write”. The method also determines a classification of the rule, such as “validation”, “computation”, “decision”, etc. and stores pointers back to the program code so that a user may review the code in order to understand it better.

In addition to these attributes of the rule, which are determined automatically by the system using a conventional parsing program, for example, other attributes may be determined such as “free format description”, “message issued”, or “audit status”.

As already noted, the storing of the rule may include storing information about the rule and where it is located in the program. More specifically, such information may include the program name, starting line numbers and ending line numbers. As already noted, the business rules can be identified by automatically inspecting the code of a program, or may be done manually. The specification of the business rule may also involve storing pointers back to the program code, i.e., where the code fragments which implement the rule start and end. In a yet still more specific aspect, the stored input rule may be given a name selected from one of the name of the input data port and the field being tested.

With respect to the output business rules, the determination of the computation path may further involve determining all statements required to arrive at the value of a field before it is sent out of the program through the output data port. As in the case with the input rule, the storing of the rule and information about where the rule is located may include the program name, starting line number and ending line number. The business rule may also be classified as is the case of the input business rules, and pointers stored back to the program code. Similarly to the input business rules, the stored rule may be given a name selected from one of the name of the output data port and the original field in the upward data structure. The rule may be identified by automatically inspecting the code of the program or may be done by manually inspecting the code of the program.

After a business rule is identified, the system may collect additional information about it. Having pointers to the code fragments which implement the rule, it may automatically compute which are the input and output data elements of the rule itself. For instance, if a rule computes the age of a person based on the birth date and current date, the system may determine automatically that the inputs to the rule are the birth date and current date and that the output of the rule is the age. The input data elements are identified as those referred by the rule, which are initialized somewhere outside of the code fragments of the rules, but do not receive any value in the rule. The output data elements are those which are initialized in the code segments of the rule, and only referred outside those code fragments, without receiving any assignments outside these code segments.

More specific implementations may be used to identify, specify and classify the rules.

One such implementation is to use the field which contains the message issued to the user after a validation. The message field is in fact an output. However, the computation rule for the message is really a validation rule, usually associated with output data. For example, the system may discover that somewhere in the program a test is performed on the state portion of an address and a message is created which tells the user that the “state is invalid”. The validation rule is determined by the assignment to the message field and by the test which leads to that assignment. The name of the rule could be automatically determined by the content of the message, for instance “SEX MUST BE F OR M”.

Another method is based on identifying special “HANDLE” conditions. The “HANDLE” conditions are syntactic constructs in a program which tell the program what it must always do if a particular condition arises. For example, a statement in a program may indicate that if record is not found in a file, then a particular routine should be executed. In this case a rule is identified which points to the “handle” statement and to the routine executed in case the condition in the “handle” statement arises. The name of the rule is formed by the name of the condition (for example “In case of RECORD-NOT-FOUND execute REJECT routine”).

The rules identified by the methods described above may be presented to the user in a number of ways. The simplest form to present the rules is in a list available in a presentation program. The user may click on a rule in the list and the program will show all details of the rule, including the name, classification, rule input and outputs and the corresponding code segments which implement the rule. Alternatively, the rules may be presented in a report which may be printed.

While this presentation of rules is useful, it does not show the rules in the context of the processes in which they are invoked. For instance, it may be important for the user of the system to know that the rule “Phone number must have seven digits” is used exactly at the point when an application for a loan is processed. It may also be important to know that this application acceptance process is run only after, for example, another process is sorting all applications by the state of origin of the applicant. This presentation of rules in the context of a dynamic process is called here contextualization.

In order to contextualize the rules, the system will first automatically create a diagram of internal routines of the program which implements the rules. The construction of such a diagram is commonly known and it exists in a number of software tools which are commercially available. By routines we mean here syntactical constructs of the program which represent units of code that are always executed together. Depending of the language, the routines may be paragraphs (as in the COBOL language), subroutines or functions (as in the PL/1 language) or methods (as in C++ or Java). In the context of this invention we will call these routines “processes.” This process diagram could be extracted automatically based on information about the program which is extracted during the automatic parsing of the programs with state of the art parsing techniques. In order to make this diagram more meaningful, the user of the system is allowed to give user-friendly names to the processes. For instance, a routine or paragraph or method called 0040-PROC-APP could be renamed by the user as simply the “Process Application” process. The diagram will visually show the interaction between the processes, indicating for instance the order in which they are run or how they interact with one another. The following table illustrates how rules could be presented in such a “Process Application”.

The first column of the table shows processes in the application. The second column shows the outline of the process and where in the process the rules are involved. The third column shows the rules themselves.

Process Outline Report for COBOL gss.cbl

Report generated at 11:28:52 AM Apr. 14, 2004

| Process | Outline | Rule Segments |
|---|---|---|
| MAINCALC | if year not equal curyear | |
| | then | Rule: ScreenValidation000007 Validation of field |

| | |
|---|---|
| CASE year not | GSS1003-DOW-YEAR-l through variable YEAR in |
| equal curyear | screen GSS1003 at line 385 |
| | Segment (1/1). File: SOURCES\COBOL\GSS.CBL |
| Rule: | Lines 385-392 |

| | |
|---|---|
| ScreenValidati | IF YEAR > CURYEAR THEN |
| on000007 | MOVE YEAR TO INT0001 |
| Rule: | MOVE CURYEAR TO INT0002 |
| ScreenValidati | move 1 to direction |
| on000008 | ELSE |
| | MOVE YEAR TO INT0002 |
| PERFORM | move 2 to direction |
| YEARS | MOVE CURYEAR TO INT0001. |

Rule: ScreenValidation000008 Validation of field

| | |
|---|---|
| if month not equal curmonth | GSS1003-DOW-YEAR-l through variable YEAR in |
| then | screen GSS1003 at line 396 |

| | |
|---|---|
| CASE month not equal | Segment (1/1). File: SOURCES\COBOL\GSS.CBL |
| curmonth | Lines 396-397 |

| | |
|---|---|
| | if year not equal curyear then |
| | PERFORM YEARS. |
| Rule: | |

| | |
|---|---|
| ScreenValidation0000 | Rule: ScreenValidation000009 Validation of field |
| 09 | GSS1003-DOW-MONTH-l through variable MONTH in |
| Rule: | screen GSS1003 at line 399 |
| ScreenValidation0000 | |
| 10 | Segment (1/1). File: SOURCES\COBOL\GSS.CBL |
| | Lines 399-406 |

| | |
|---|---|
| | IF MONTH > CURMONTH THEN |
| | MOVE MONTH TO INT0001 |
| | MOVE CURMONTH TO INT0002 |
| PERFORM MONTHS | move 1 to direction |
| | ELSE |

| | |
|---|---|
| if day1 not equal curday then | MOVE MONTH TO INT0002 |
| | move 2 to direction |
| | MOVE CURMONTH TO INT0001. |

CASE day1 not equal

| | |
|---|---|
| curday | Rule: ScreenValidation000010 Validation of field |
| | GSS1003-DOW-MONTH-I through variable MONTH in |
| | screen GSS1003 at line 408 |
| Rule: | |
| ScreenValidation0000 | Segment (1/1). File: SOURCES\COBOL\GSS.CBL |
| 11 | Lines 408-409 |

| | |
|---|---|
| Rule: | if month not equal curmonth |
| ScreenValidation0000 | then |
| 12 | PERFORM MONTHS. |

| | |
|---|---|
| PERFORM DAYS | Rule: ScreenValidation000011 Validation of field |
| | GSS1003-DOW-DAY-I through variable DAY 1 in screen |
| | GSS1003 at line 411 |
| | Segment (1/1). File: SOURCES\COBOL\GSS.CBL |
| | Lines 411-418 |

IF DAY1 > CURDAY THEN
MOVE DAY1 TO INT0001
MOVE CURDAY TO INT0002
move 1 to direction
ELSE
MOVE DAY1 TO INT0002
move 2 to direction
MOVE CURDAY TO INT0001.

Rule: ScreenValidation000012 Validation of field
GSS1003-DOW-DAY-I through variable DAY1 in screen
GSS1003 at line 420
Segment (1/1). File: SOURCES\COBOL\GSS.CBL
Lines 420-421

if day1 not equal curday then
PERFORM DAYS.

| | | |
|---|---|---|
| [0010] [0010] | PERFORM ISV | |
| [0010] TTY | | Rule: ScreenValidation000013 Validation of field |
| | | GSS1003-DOW-MONTH-I through variable MONTH in |

| | |
|---|---|
| Rule: ScreenValidation000013 | screen GSS1003 at line 435 |
| | Segment (1/1). File: SOURCES\COBOL\GSS.CBL |
| | Lines 435-435 |

| | |
|---|---|
| | if month > 2 then add 1 to |
| | tmpl. |
| TTY1 | |

| | | |
|---|---|---|
| TTY2 | PERFORM TTY1 | |
| ISV | | |
| YEARS | PERFORM TTY | |
| | | Rule: ScreenValidation000014 Validation of field |
| | | GSS1003-DOW-MONTH-I through variable INT0002 in |

| | |
|---|---|
| Rule: ScreenValidation000014 | screen GSS1003 at line 468 |
| | Segment (1/1). File: SOURCES\COBOL\GSS.CBL |
| | Lines 468-469 |

| | | |
|---|---|---|
| | | PERFORM TTY VARYING INT0002 |
| | | FROM INT0002 |
| | | BY 1 UNTIL INT0002 EQUAL |
| | | INT0001. |
| MONTHS | PERFORM ISV | |

| | |
|---|---|
| PERFORM TTY2 | Rule: ScreenValidation000015 Validation of field |
| | GSS1003-DOW-MONTH-I through variable MONTH in |
| | screen GSS1003 at line 471 |

| | |
|---|---|
| Rule: ScreenValidation000015 | |
| Rule: ScreenValidation000016 | Segment (1/1). File: SOURCES\COBOL\GSS.CBL |
| | Lines 471-474 |

if month > 2
MOVE tmp4 TO tmp1
else
move tmp4 to tmp1.

Rule: ScreenValidation000016 Validation of field
GSS1003-DOW-MONTH-I through variable INT0002 in
screen GSS1003 at line 477
Segment (1/1). File: SOURCES\COBOL\GSS.CBL
Lines 477-478

PERFORM TTY2 VARYING INT0002
FROM INT0002 BY 1
UNTIL INT0002 EQUAL INT0001.

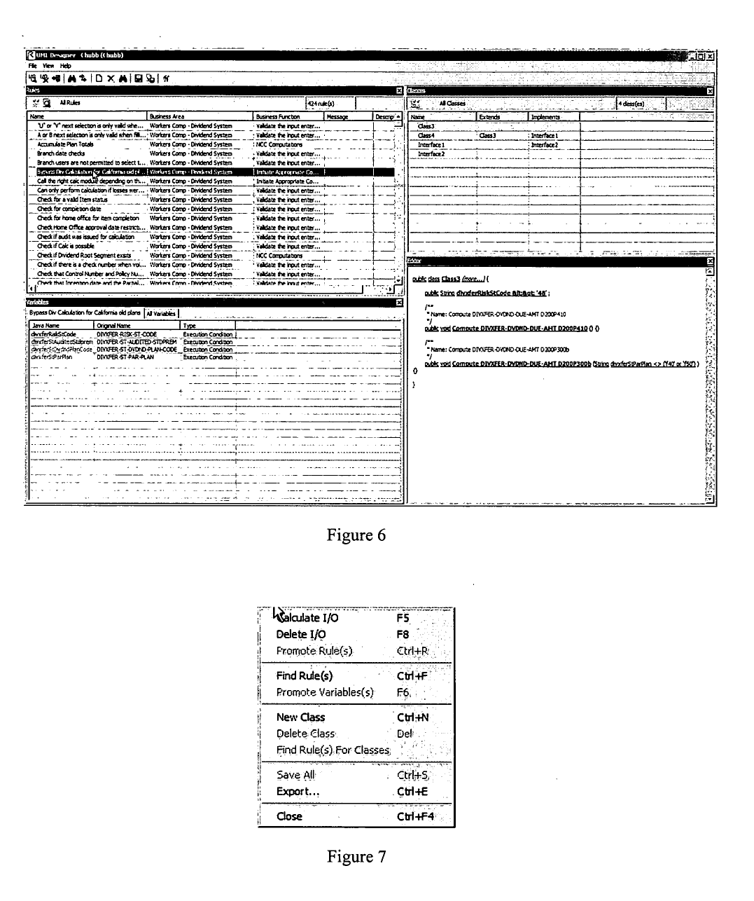

Once the diagram is created, the system will also graphically attach the name of every rule implemented in the program to the corresponding routines which contain the fragments of the code that implement the rule. It may show, for example that the “Store application data” process will run after the “Verify application” process and that the “Phone number should be 7 digits” rule is invoked by the “Verify application” process, while the “No duplicate applications allowed” is invoked by the “Store application data” process. FIG. 6 shows a possible implementation of the rule contextualization described here.

In accordance with a further aspect of the invention, a software tool has been developed for the purpose of creating a class diagram. Implementation of the tool in terms of specific programming will become readily apparent to those of ordinary skill in the art from the following detailed discussion which follows.

The tool takes information from a legacy system and through automatic and manual operations facilitates creating of a class diagram by a user. The class diagram can then be exported (as a UML model in a XML file that is compliant with XML1.4 OMG specifications). The model can be further imported, enhanced and maintained in an advanced UML editor (like Togethersoft).

In accordance with the invention, through the methods implemented through the tool, and the results generated, a user can create an object-oriented design for a legacy system based on information extracted from the legacy system.

In order to implement the tool, the inputs and outputs of business rules must be computed, for example, in a manner as previously described herein. The business rules are imported into the UML tool and the input and output variables associated with the rules are calculated. The rules are defined and transformed into methods of the class. The rules variables are defined either as the method's parameters or as global attributes of the class to make the design of the classes more flexible.

Inheritance between modeled objects is also possible using the tool. By the term “inheritance” is meant the fact that a class has all the data and methods which also exists in another class (from which it inherits).

The system has a number of filters which allows the user to select the rules to be used in the model, based on some user-defined criteria.

The user starts by identifying the objects of the legacy application. For example, an object may be a customer. Variables related to the customer are known as attributes. There are business rules related to an object and they may be identified based on the fact that they operate with the attributes of the object. Thus, in accordance with the invention, all of the objects in a legacy system are identified such as customers, accounts, branches, etc. More specifically, the entire universe of objects in the legacy system is identified. For each object, the data elements in the system which refer to the object are also identified. Data elements are identified by clues which refer to the object such as customer name, customer number, etc.

Although this identification of attributes is a manual activity, in essence it is very simple, since all data elements making up the attributes of an object are usually grouped in a legacy record, as for instance CUSTOMER-RECORD. This record would have subfields which are in fact the attributes of the object (as of instance CUSTOMER-NAME, CUSTOMER-ADDRESS, etc.) Since the input and output data elements of a rule are already calculated, as explained above, the tool is programmed to list all the business rules which deal with the data elements. The user selects the data element and the tool returns what business rules deal with the data element.

Thus, in its most fundamental aspects, the invention involves identifying the business rules in the legacy system and computing the input and output for each business rule. A heuristic method is used to determine the objects within the legacy system. The data elements related to an object are determined and then the system finds all the rules that involve data elements for this particular object.

The user thus proceeds in the following steps: (1) heuristically identify the objects of the application; (2) manually identify the data elements related to each object (called here candidate attributes); and (3) automatically find all the business rules for which these data elements of an object are inputs or outputs. These rules are now designated as candidate methods.

Having specified the object, the candidate data attributes associated with the object, and the candidate methods for the object, a class for the object and its associated elements can then be specified by simply selecting some or all of the candidate attributes and methods This is repeated for every object in the legacy system to create a class diagram which is exportable as an XML file to result in the creation of an object oriented design for the legacy system.

The tool described here has four panes as shown in FIG. 6. The first pane shows the list of existing business rules which were previously discovered. The user may use some filters, such that only some of the rules will be shown, based on some restrictions on rules properties. The second pane shows all the variables associated with a rule or a number of rules, grouped in input and output variables. The user may accept suggested Java names for the variables or may enter new names. The third pane shows a list of all classes which are already defined through this tool. The fourth pane is the editor view and shows all the properties of a class derived from the business rules

In use, when the tool is open, if there are any business rules computed as previously described, then they are shown as a list in the first pane, as described above. When a rule is selected, then the associated variables, i.e., variables which were found to be inputs or outputs of the selected rule are automatically shown, If there are no variables associated with the selected rule, then the list is empty. As also shown in FIG. 6, if any model has been previously saved with the UML designer tool, then the tool is open and the model is loaded and the classes and editor view shown therein.

Any number of business rules can be selected and the input/output variables calculated through the “Calculate I/O” menu item under the file menu or the corresponding button, for example, as illustrated in FIG. 7. If the variables have already been calculated, then the previous ones are deleted and recalculated when executing the “Calculate I/O” command. Some new variables may be entered manually and in this case the variables which have been entered manually as part of the business rule identification are preserved during the calculation/recalculation. When the tool is open, the latest changes from the business rule identification are reflected into the UML designer tool (both for the rules and the associated variables).

The calculation of the input and output variables for a business rule is done as described hereafter. The rule points to a number of lines of code (which implement the rule). Those lines of code represent various operations performed on a number of variables. If a variable only gives values to other variables, it is considered an input. If a variable only receives values it is considered an output. For instance, if the code of the rule consists of two statements, MOVE A TO B and MOVE B TO C, then A will be input and C will be output, while B is neither input nor output.

The “Delete I/O” menu from the file menu allows the user to delete only the automatically computed I/O variables for the rules selected in the rules view. Once an automatically generated variable is edited outside the UML designer tool, the variable is no longer considered automatically generated but manually entered instead.

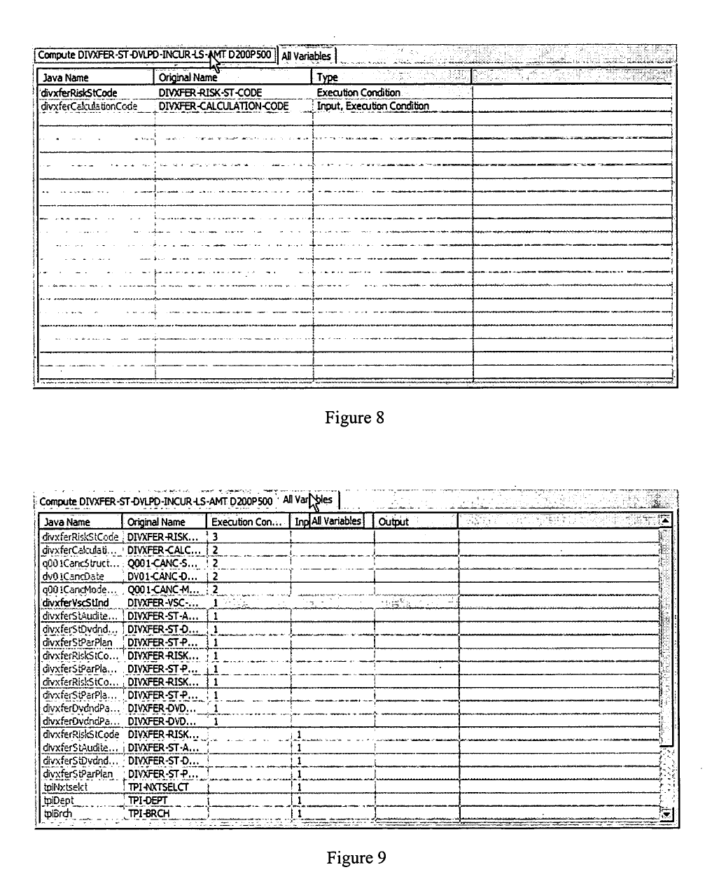

The variables and their associated type are shown in the variables view for each business rule selected on the first tab, or as a list of all variables on the all variables tab, regardless of the number of rules selected. As shown in FIG. 8, on the first tab if there is more than one type defined for the same variable name, then the types are separated by a comma.

As shown in FIG. 9, when switching to the “All variables” panel, each business type is displayed as a separate column, and the variables are taken into consideration only once into the list.

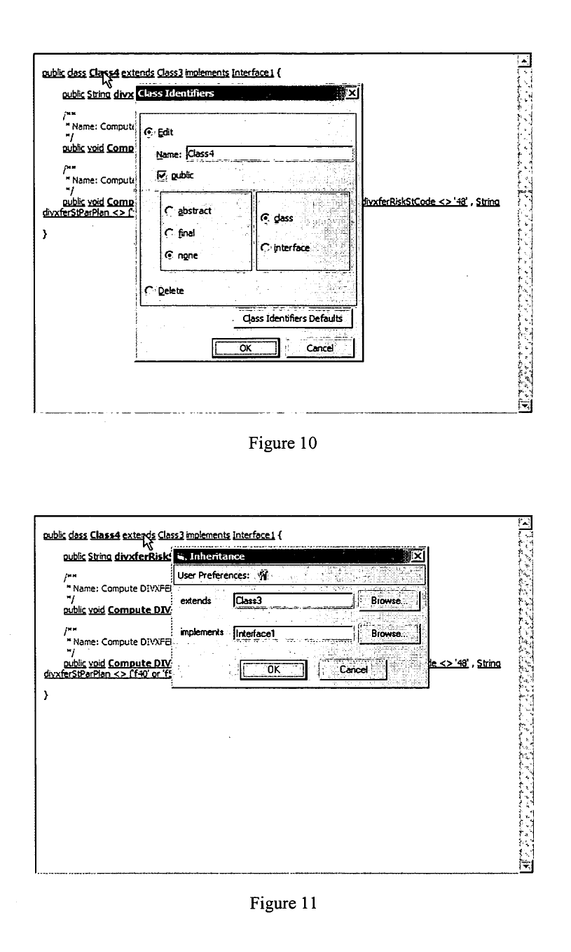

The system is designed to automatically derive Java style names for each one of the legacy style name. For instance, if a variable is called CUSTOMER-NAME in Cobol, it may become customerName in Java. The Java names of the variables can be edited. Once a variable name is edited, the color of the name is changed in the list from grey (unedited) to black (edited). Selecting “New class” from the file menu or by pressing the appropriate button will create a new item in the classes list view. In the editor view, the Java code associated with the new class is displayed. As shown in FIG. 10, the default values for the class header are:
public Class Class# (More . . . ){ }

Class names can be further edited from the editor view only. The UML model is saved automatically each time the tool is closed or manually when using the “Save all” menu item from the file menu, or the appropriate button. Once the model is saved, the “Save all” button becomes disabled. It becomes enabled when a change occurs in the model.

The model can be exported in an XML file with an XMI OMG 1.4 format using the “Export” menu item or the appropriate button. The XML file can be further imported in an advanced UML tool that supports XMI 1.4 specification (for example, Togethersoft), to continue the modeling and/or generate code associated with the class diagram. The “Delete class” menu item, or appropriate button, deletes a selected class(es) from the model. If there is no selected class in the list, then the menu item the associated buttons are disabled.

The “Promote rules” menu item, or appropriate button, becomes enabled when a rule is selected under the rules view and there is at least one class selected under the classes view. The “Promote rules” menu item is otherwise disabled. This item serves to insert all selected rules as methods in the current class and their associated variables as parameters of the methods. The default modifiers for methods and parameters are as shown in FIG. 10:
public void methodName (String paramName, . . . ) { }

The “Promote variable” menu item becomes enabled when a variable is selected in the first tab in the “Variables” view and there is at least one class selected under the “Classes” view. It is otherwise disabled. This menu item serves to insert all selected variables as global attributes in the current class. The default modifiers for attributes are;
public String attributeName

Anytime a rule is promoted as a method, the “Rules” view marks a check mark to indicate that the rule is already being used in the model. The class identifiers are edited using the dialog shown in FIG. 10. When any of the identifiers are selected, the dialog will pop up. The class can also be deleted using the dialog.

As shown in FIG. 11, by selecting the links following the class identifiers, it is possible to add inheritance for an object. The inheritance will be reflected under the classes view as well.

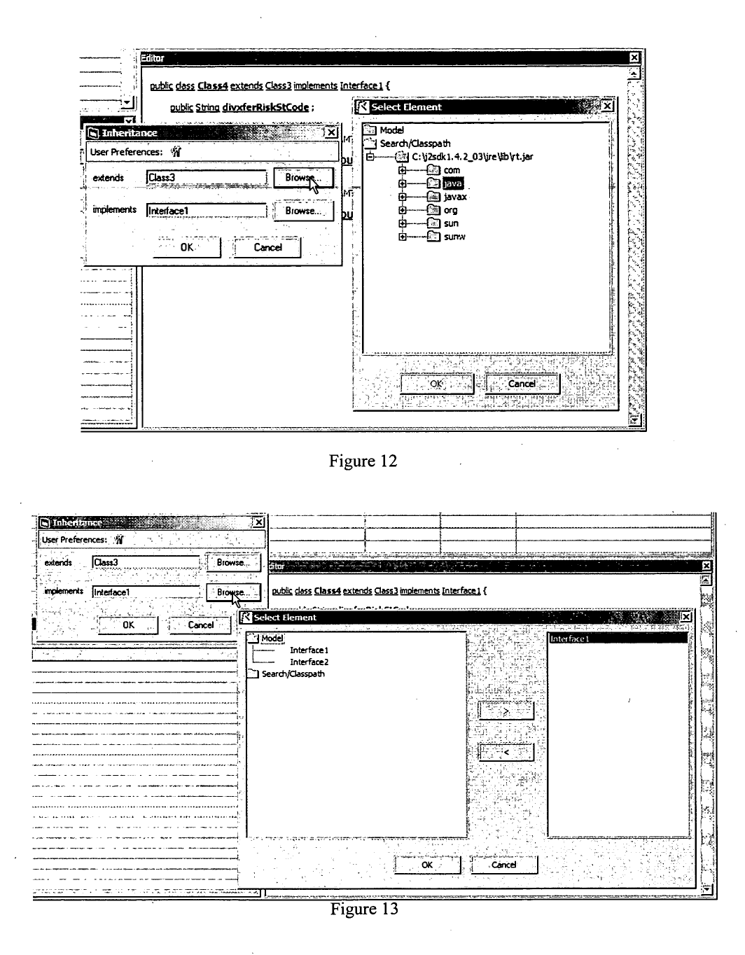

In order to extend an object, the user merely needs to hit the upper “Browse” button, and then select the object from a list either in the existing model or in one of the available Java libraries using the dialog shown in FIG. 12. The “extends” clause will provide the mechanism to implement the inheritance between classes.

Similarly, in order to implement an interface, the user merely needs to hit the lower “Browse” button and then select the object from a list either in the existing model or in one of the available Java libraries using the dialog shown in FIG. 13. The “implements” clause will then provide a mechanism to implement interfaces.

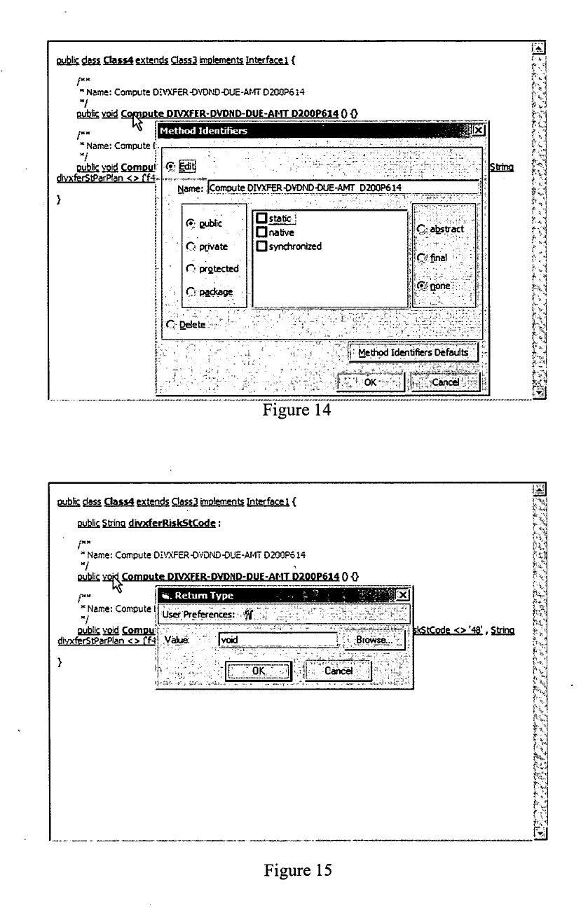

As shown in FIG. 14, the method identifier can be edited by selecting the appropriate links. All method signatures are edited within one dialog, and the method can be deleted from the class using the same dialog.

FIG. 15 displays a dialog which is used to edit the return type of method and the types of parameters or other attributes by selecting the appropriate links.

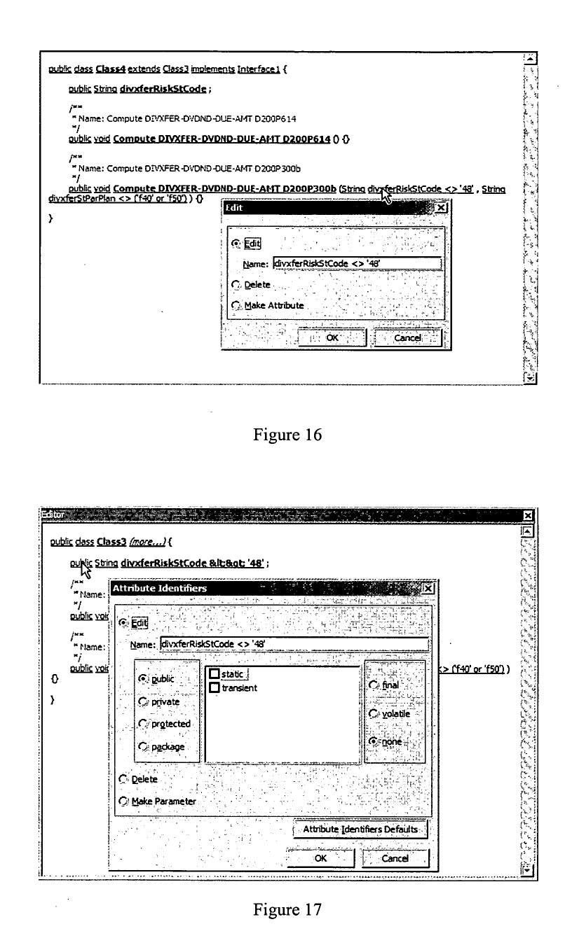

As shown in FIG. 16, the method parameters can be moved up as global attributes of the class and vice versa. Global attributes can be moved back into the method where they came from. Similarly, a parameter can be edited, deleted, or made an attribute through the dialog shown in FIG. 16.

Similarly, an attribute can be edited, deleted or made an attribute in the dialog shown in FIG. 17.

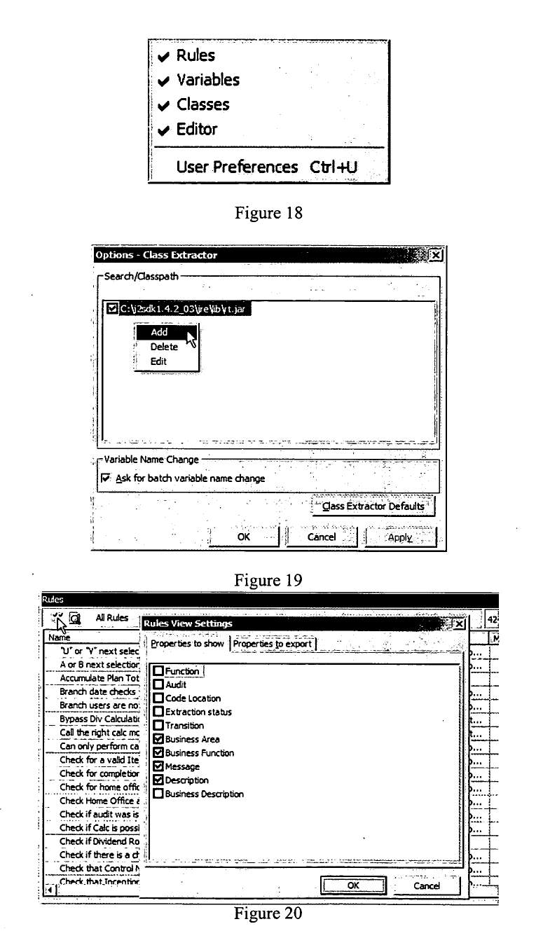

Through the view menu, it is possible to show or hide any of the four panels of the tool and set the user preferences as shown in FIG. 18. Thereafter, through the “User preferences” it is possible to set the Java libraries available to the UML designer tool and set the batch variable check button as desired. The check button is for displaying or not displaying a dialog when a Java name is edited in one of the variables view lists. By default it is checked as shown in FIG. 19.

The various filtering aspects of the system are illustrated in FIGS. 20-22.

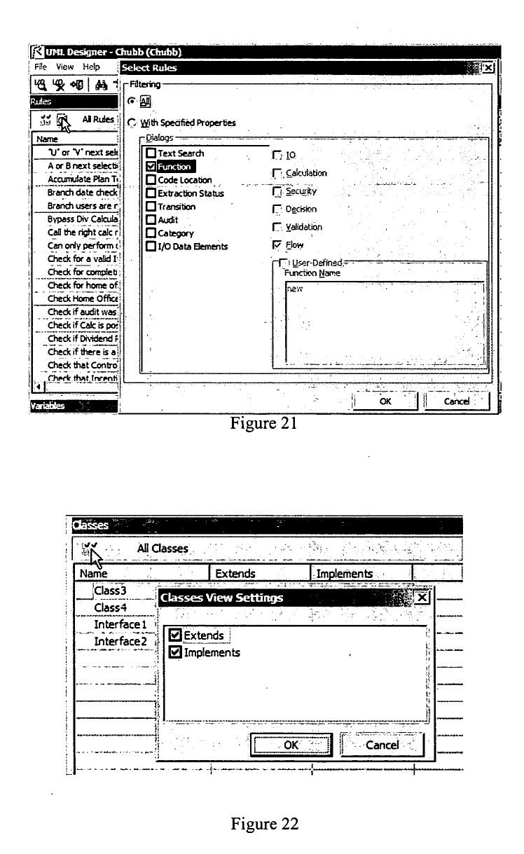

As the number of rules available may be very large, the user may want to see only some of them, based on some filter. “Filter the rules” button displays this dialog in FIG. 21. It is used to filter the rules to be shown in Rules view, based on a number of restrictions on rules properties. For instance, one of the filtering criteria is to show only “computation” rules.

The user may also decide to see only some of the properties of a class. As shown in FIG. 22, the “Filtered properties” button in the Classes view refers to the classes' properties to be displayed in the view.

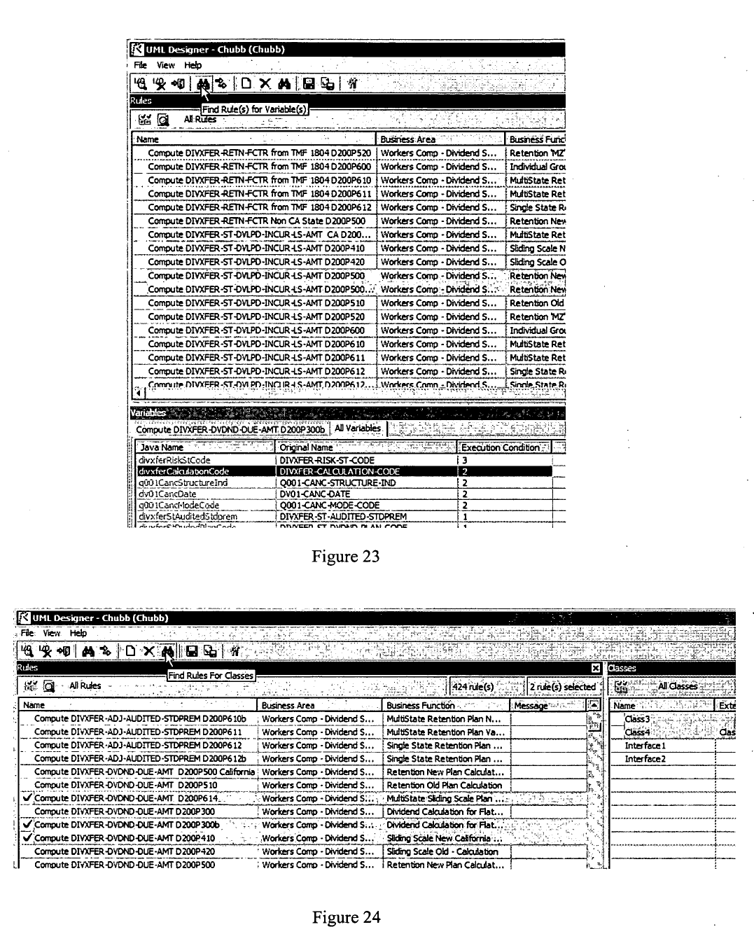

As shown in FIG. 23, the “Find rules for variables” item in the file menu is used to search all the rules that contain the selected variables. Once the rules are found they are highlighted in the rules view shown in FIG. 23.

As shown in FIG. 24, the “Find rules for classes” item from the file menu is used to find all the rules that were promoted as methods in the classes selected. They are highlighted in the rules view shown in FIG. 24.

As will be appreciated by those of ordinary skill in the art, the model created with the UML designer tool is persistent so that when the tool is closed the model is saved automatically and when the tool is opened the model was loaded back in the appropriate views. In this manner, the method and system is used in creating an object or in a design for a legacy system.

Having thus generally described the invention, the same will become better understood from the appended claims in which it is set forth in a non-limiting aspect.

1. A method of grouping variables in legacy program code of a program to describe the program, comprising:
identifying objects in the program code;
for each object identified, identifying data elements in the program which refer to each object;
identifying what business rules deal with the identified data elements;
selecting data elements and business rules to be associated with each identified object; and
creating a class for each identified object which is comprised of the object and data elements and business rules selected for association with the respective object.

2. The method of claim 1, wherein said business rules are identified by:
identifying all input ports in the program code;
determining the data structure associated with each input port;
for each field in each input port, determining the outgoing data flow;
for each field in the data flow, determining if there is a test used to create an error message or a warning message about that data element; and
if a test exists, creating a validation rule, and storing the rule.

3. The method of claim 1, wherein said class for each object is created by selecting all of the data elements and all of the business rules related to each object.

4. The method of claim 1, wherein said class for each object is created by selecting only some of the data elements and some of the business rules related to the object, and deselecting those identified business rules and data elements which are not intrinsically related to the object or which is redundant.

5. The method of claim 1, further comprising creating data attributes for each object by abstraction from the related data elements, and forming said class as an association between the object and the data attributes.

6. The method of claim 1, further comprising creating methods for each object by abstraction from the selected business rules, and forming said class as an association between the object and the methods.

7. The method of claim 1, further comprising creating data attributes for each object by abstraction from the related data attributes for each object by abstraction from the selected data elements, creating methods for each object by abstraction from the selected business rules, and forming said class as an association between the object, the data attributes and the methods.

8. The method of claim 1, further comprising assembling all classes created into a class diagram.

9. The method of claim 8, further comprising creating said class diagram as a UML model.

10. The method of claim 9, wherein said class diagram comprises an object oriented design for a legacy program.

11. A system for grouping variables in legacy program code of a program to describe the program, comprising:
means for identifying objects in the program code;
means for identifying data elements in the program which refer to each object identified in the program;
means for identifying business rules which deal with the identified data elements;
means for selecting data elements and business rules to be associated with each identified object; and
means for creating a class for each identified object comprised of the object, data elements and business rules selected for association with the respective object.

12. The system of claim 11, further comprised of means for identifying said business rules, said means for identifying comprising:
an interface constructed for displaying all input ports and all output ports in the program code;
said interface further comprising, means for determining the data structure associated with each input port and with each output port, means for determining the outgoing data flow for each field in each input port and means for determining the computation path for each field in each output port;
means for determining if there is a test used to branch in the program for each field in the input port outgoing data flow, and storing the validation rule if a test exists; and
means for determining if the computation path is not empty for each computation path of each output data port, and means for creating a computation rule and for storing the computation rule if the computation path is not empty.

13. The system of claim 11, wherein said means for creating said class further comprises means for selecting all of the data elements and all of the business rules related to each object.

14. The system of claim 11, wherein said means for creating said class for each object further comprises means for selecting only some of the data elements and some of the business rules related to the object, and for deselecting those identified business rules and data elements which not intrinsically related to the object or which is redundant.

15. The system of claim 11, further comprising means for creating data attributes for each object by abstraction from the selected data elements, and for forming said class as an association between the object and the data attributes.

16. The system of claim 11, further comprising means for creating methods for each object by abstraction from the selected business rules, and for forming said class as an association between the object and the methods.

17. The system of claim 11, wherein said means for creating said class for each object further comprises means for creating data attributes for each object by abstraction from the selected data elements, and for creating methods for each object by abstraction from the selected business rules, and forming said class as an association between the object, the data attributes and the methods.

18. The system of claim 1, further comprising means for assembling all classes created into a class diagram.

19. The system of claim 18, wherein said means for assembling is configured for assembly class diagram as a UML model.

20. The system of claim 19, wherein said class diagram comprises an object oriented design for a legacy program.
